(19) United States
(12) Patent Application Publication
(10) Pub. No.: US 2025/0276884 A1
(43) Pub. Date: Sep. 4, 2025

(54) Method and Device for Controlling a Hydraulic Lifting Drive of a Mobile Work Machine

(71) Applicant: STILL GmbH, Hamburg (DE)

(72) Inventor: Niko Siemering, Hamburg (DE)

(21) Appl. No.: 18/281,103

(22) PCT Filed: Mar. 1, 2022
(86) PCT No.: PCT/EP2022/055062

§ 371 Date: Jan. 23, 2024

(30) Foreign Application Priority Data
Mar. 10, 2021 (DE) 10 2021 105 748.5

(51) Int. Cl. B66F 9/075

(52) U.S. Cl. CPC B66F 9/0759

(57) ABSTRACT

A method is disclosed for controlling a hydraulic hoist unit of a mobile machine for raising and lowering load handling means. The hoist unit has a lift cylinder device and a control valve device connected to a consumer line that leads to the lift cylinder device, to a reservoir line leading to a reservoir, and to a delivery line connected to a pump. An operator controls the raising and lowering of the control valve device. When there is no load on the load handling means during lowering of the hoist unit, the operator, by actuating an authorization actuation element while simultaneously operating the hoist unit control element, authorizes a high-speed lowering, during which a lowering flow volume discharged from the hoist unit is increased by a cross section expansion by a cross section expansion device.

### CROSS-REFERENCE TO RELATED APPLICATIONS

This application is the United States national phase of International Application No. PCT/EP2022/055062 filed Mar. 1, 2022, and claims priority to German Patent Application No. 10 2021 105 748.5 filed Mar. 10, 2021, the disclosures of which are hereby incorporated by reference in their entireties.

### BACKGROUND OF THE INVENTION

### Field of the Invention

The invention relates to a method for controlling a hydraulic hoist unit of a mobile machine, in particular of an industrial truck, to raise and lower load handing means, wherein the hoist unit has a lift cylinder device and a control valve device that is connected to a consumer line that leads to the lift cylinder device, to a reservoir line that leads to a reservoir, and to a delivery line that is connected with a pump, wherein an operator controls the lifting and lowering of the hoist unit by manually operating a hoist unit control element that is linked with the control valve device.

The invention further relates to a device for the performance of the method.

### Description of Related Art

To handle loads, industrial trucks are provided with load handling means which are generally formed by a lift carriage that can be raised and lowered on the mast construction and an attachment element fastened to it. The attachment element can be in the form of a load fork consisting of fork tips, for example, which can be run underneath a load such as a pallet, for example.

On industrial trucks on which the load handling means can be raised and lowered by means of a hydraulic lift cylinder device, the speed of descent of the load handling means is determined by the deflection of the control valve during the lowering operation. In recent years, a limit value of 0.6 m/s has been established for a maximum speed of descent of the load handling means or of a load.

To limit the maximum speed of descent during lowering, it is already known that a discharge pressure balance can be located in the reservoir line that leads from the control valve device to the reservoir, which discharge pressure balance is actuated toward an open position by a spring device and the pressure present in the reservoir line between the control valve device and the discharge pressure balance, and toward a closed position by the pressure present in the consumer line. If, in such hoist units a raised load or empty load handling means are to be lowered, the control valve device is actuated into an open position in which the consumer line is in communication with the reservoir line. The discharge pressure balance is connected to the control valve device in series. When the control valve device is opened, a lowering flow volume begins to flow via the control valve device and the discharge pressure balance from the lift cylinder device to the reservoir, and the load handling means are lowered. The maximum flow volume for lowering the load handling means is limited by the setting of the discharge pressure balance. On one hand, the pressure in the consumer line upstream of the control valve device impinges on the discharge pressure balance toward a closed position and, on the other hand, the spring force of the spring device and the pressure in the reservoir line between the control valve device and the discharge pressure balance, and therefore the pressure downstream of the control valve device, impinge on the discharge pressure balance toward an open position. The lowering flow rate increases until a maximum pressure drop of 4 bar, for example, is established on the control valve device, which corresponds to the spring force of the discharge pressure balance. The discharge pressure balance moves into the control position and travels toward the closed position until this pressure drop is held constant at, for example, 4 bar on the control valve device.

During lifting operations of hoist units with lifting frames that have a plurality of lifting stages, for example on a lifting frame that has a free lift as the first lifting stage and a mast lift as the second lifting stage, during lowering at low load pressures, for example load pressures below approximately 30 bar, in the first lifting stage maximum speeds of descent that are too low are set because the control valve does not open far enough for this type of operation, or the series connection of the control valve device and the discharge pressure balance presents excessive resistance. Therefore the low load pressure to lower the load handling means is not sufficient to achieve the required maximum speed of descent.

On hoist units of this type, for this operating condition of lowering with low load pressures, the control valve device would have to open much wider to achieve higher speeds of descent. However, that would mean that with higher load pressures, for example load pressures greater than 30 bar, unallowably high speeds of descent of the load handling means would occur.

Overall, during operation of a hoist unit of a mobile machine, particular attention must be paid to the following three core technical problems:

### 1) The Lowering Process

The lowering process of the load handling means is conventionally controlled by a lever position of the hoist unit control element. The hoist unit control element is thereby deflected in a specified direction. The deflection of the hoist unit control element is proportional to the desired speed of descent. The maximum lever deflection of the hoist element control element corresponds to the maximum speed of descent. The lever position of the hoist unit control element gives a setpoint signal to a valve spool of the control valve device. The further opening of the valve spool of the control valve device means that a higher flow rate can pass through and the load can therefore be lowered more rapidly.

As a result of the valve spool opening, i.e. the piston travel, of the valve spool of the control valve device, an opening of the cross section occurs. The flow rate through a cross section is a function of, in addition to the size of the cross section opening, the pressure difference across the cross section, which is also called “motive pressure”. The motive pressure on the lift frame side is a function of the load carried, and is maximum at the nominal load and decreases with a lower load. After the size of the opening cross section, the pressure is a function of the pressure losses caused by the construction of the hydraulic system. The greater the pressure loss, the lower the motive pressure.

Additional control components/switching elements are generally installed in a valve block of the control valve device to qualitatively modify the lowering process. These components have a negative influence on the line losses.

The speed of the load handling means therefore results from a combination of the lever position of the hoist unit control element, the size of the opening cross section of the control valve device, the pressure loss and the motive pressure.

The lowering process must be qualitatively modulated. For this purpose there are a variety of components in the valve block, such as the discharge pressure balance, for example.

Because the operating point with the nominal load and warm hydraulic medium (on account of the lowest viscosity, these is where the lowest pressure losses occur) and full valve spool opening of the control valve device allows the fastest descent, this case must be used for the tuning of the system. Because this is when the viscosity is at its lowest, this is where the lowest pressure losses occur. All other operating points are taken into consideration, but must be secondary to this requirement.

The greatest disadvantage therefore occurs during lowering without a load, because in that case the load pressure is lowest and pressure losses to the same extent do not occur.

It would be desirable to eliminate the disadvantage of a low no-load lowering speed and to bring the no-load lowering speed to a level significantly greater than 0.6 m/s.

Lowering without a load covers approximately 50% of all lowering processes in the operation of a machine such as an industrial truck, for example. That results in significant performance disadvantages, especially with high mast constructions such as on reach trucks, for example.

During operation, it is repeatedly necessary to wait for the empty load handling means.

Lowering without a load is thereby significantly less critical than with a load. A very high speed of descent would be conceivable and desirable here.

### 2) Actuation

The lowering process, like any hydraulic section request, is controlled in particular by means of a simple, single lever position on the hoist unit control element. A simple deflection of the hoist unit control element results in a movement of the hydraulic section, for example for the hoist unit lowering process.

The closed-loop control circuit includes the operator, who must decide how rapidly, i.e. with what lever position of the hoist unit control element the load picked up can be lowered. The maximum speed of descent with the nominal load does not result in dangerous vehicle conditions if the load capacity diagram is observed.

### 3) Load Detection

Load detection generally means a technical system which is installed on the mobile machine and identifies and analyzes the load on the load handling means. A combination of different sensors is often necessary.

### SUMMARY OF THE INVENTION

The object of this invention is a method as well as a device for the performance of the method so that faster lowering speeds of the load handling means can be achieved in a simple manner in the absence of a load.

According to the invention, this object is accomplished by a method in which the operator, when there is no load on the load handling means, by actuating an authorization actuator element and simultaneously operating the hoist unit control element during the lowering of the hoist unit, authorizes a high-speed lowering operation, in which a lowering volume rate flowing out of the hoist unit is increased by expanding the cross section of the hydraulic line path from the hoist unit to the reservoir.

The hoist unit control element is appropriately in the form of a deflectable lever such as a joystick, for example. The lifting process and the lowering process are controlled by deflecting the lever.

On the other hand, the authorization actuation element can be in the form of a simple button, for example. The high-speed lowering operation can be authorized by simultaneously pressing the button during the deflection of the lever with which the lowering process is controlled. For this purpose the button can be located in an ergonomically favorable manner on the side of the lever so that it can be depressed with the thumb of one hand while the lever is being deflected with the same hand.

The invention addresses the three core problem areas described above simultaneously, and by means of a combined solution for all the core problem areas creates a new form of lowering deflection with positive consequences for the performance of the hoist unit.

The operator, who on account of legal and regulatory requirements must be on the mobile machine, such as on the industrial truck, for example, when the lever is deflected, knows the composition and weight of the load being picked up with the load handling means. The operator must have this information to remain within the requirements of the load capacity diagram during operation of the mobile machine.

With regard to the core problem area (3) (load detection) described above, the invention teaches that the operator only has to decide whether there is a load (regardless of its weight) on the load handling means, for example on the load fork, or whether the load handling means are empty. The case of an empty load handling means i.e. when no load is present, is thereby called “no load”.

The operator therefore performs a load detection and decides whether the load handling means are empty. If the load handling means are empty, all the components are solidly connected with the mobile machine and if the truck is undamaged, nothing can fall down.

The operator therefore performs a decisive role in the closed-loop control system and decides whether the load handling means are empty. If the load handling means are empty, the operator actuates the authorization actuation element while simultaneously operating the hoist unit control element. When the hoist drive control element is in the form of a lever and the authorization actuation element is in the form of a button, the operator can also depress the button, in particular while fully deflecting the lever of the hoist unit control element into the position for lowering operation. The actuation of the authorization actuation element, for example the pressing of the button, is called “two-factor authorization”, because in addition to the deflection of the lever of the hoist unit control element into lowering operation, the authorization actuation element is intentionally pressed as a second factor and must preferably be kept permanently depressed.

The operator confirms that the load handling means are empty and therefore authorizes the lowering of the empty load handling means by actively depressing the authorization actuation element, which triggers a widening of the cross section of the lowering path, which makes possible a higher flow rate and therefore a greater speed of descent. The two-factor authorization therefore ensures that the cross-section expansion from the hoist unit to the reservoir is not initiated when a load has been picked up.

Without confirmation from the operator by means of the two-factor authorization, i.e. in particular the simultaneous deflection of the hoist unit control element into the lowering position and pressing of the additional authorization actuation element, the cross section expansion is not initiated and only a conventional lowering is possible. The operator therefore acts as an additional final control element and authorizes the rapid lowering, and bears the responsibility for a safe lowering process. That is logical in particular because the operator knows what step of the process he is engaged in, his work process and the load on the load handling means.

With regard to the core problem area (2) described above (Actuation), the invention therefore multi-dimensionally expands the one-dimensional deflection of the lever as a control input command.

After the absence of the load has been detected and acknowledged by the operator by means of a two-factor authorization, the lowering flow volume discharged from the hoist unit can be increased by expanding the cross section in the hydraulic lowering path. As a result of the expansion of the cross section, the flow velocity of the hydraulic medium is reduced, which has a quadratic effect on the pressure losses. The pressure losses are reduced and the speed of descent is thereby increased.

With regard to the core problem area (1) described above (lowering process without a load), the invention achieves a reduction of pressure losses and therefore an improvement of the motive pressure, as a result of which an increased speed of descent of the load handling means is achieved during lowering of the load handling means.

According to one particularly preferred embodiment of the invention, the cross section expansion is achieved by enabling a bypass line leading from the consumer line to the reservoir. The bypass line is an additional, parallel hydraulic path of the lowering path.

An electrically actuated hydraulic bypass valve is opened to enable the bypass line. The bypass line can thereby be opened with a hydraulic switch and/or proportional valves.

The bypass line can contain additional hydraulic control elements, such as flow and/or pressure control valves, for the qualitative and quantitative control of the lowering process. The lowering speed, for example, can thereby be limited to a maximum allowable lowering speed without a load.

The bypass line can be installed in a valve block of the control valve device or can bypass the control block. According to one advantageous variant of the invention, the cross section expansion is achieved by opening an additional valve in the control valve device. For this purpose, the lowering section can be designed for a higher flow rate and an artificial tapering of the cross section can be installed which is opened by the two-factor authorization. In that case, the flow does not bypass the valve block of the control device but runs through it. The artificial tapering of the cross section is achieved by the additional valve.

In an additional configuration, the cross section expansion is achieved by directing the full flow through a lowering proportional throttle valve that carries a partial flow in lowering operation of the hoist unit. A lowering proportional throttle valve is formed, for example, by a lowering position of the control valve device. The lowering proportional throttle valve is designed for a higher flow rate and an artificial tapering of the cross section is provided, which is opened by the two-factor authorization. This can occur if the lowering proportional throttle valve is opened only proportionally and thus carries a partial flow in normal operation, and the lowering proportional throttle valve carries a full flow for the high-speed lowering operation.

One advantageous development of the teaching of the invention provides that the load pressure of the hoist unit is measured by means of a load pressure sensor and the cross section expansion is prevented if a specified load pressure is exceeded. Therefore the operator can be assisted when the presence of a load on the load handling means is detected. It is thereby important, however, that the load pressure measurement cannot automatically or by itself trigger the high-speed lowering operation. This can be done exclusively by the two-factor authorization by the operator. The purpose of the load pressure measurement is to block the triggering of the high-speed lowering operation if the load pressure measured is too high.

As an additional or alternative safety measure, the operator can also be assisted by a temperature sensor. For this purpose the temperature of the hydraulic medium is measured by means of a temperature sensor, and the expansion of the cross section is prevented if the temperature exceeds a specified temperature.

The load pressure measurement and/or temperature measurement can thereby be conducted electrically, electronically, mechanically or hydraulically.

The invention further relates to a device for the performance of the method, with a hydraulic hoist unit of a mobile machine, in particular of an industrial truck, for the raising and lowering of load handling means, wherein the hoist unit has a lift cylinder device and a control valve device that is connected to a consumer line that leads to the lift cylinder device, to a reservoir line that leads to a reservoir, and to a delivery line connected to a pump, wherein for the control of the lifting and lowering of the hoist unit, a manually operable hoist unit control element is provided that is linked with the control valve device.

In terms of the device, this object is accomplished by a method in which the operator, when there is no load on the load handling means, by simultaneously actuating an authorization actuation element and the hoist unit control element during the lowering of the hoist unit, authorizes a high speed lowering operation, in which a lowering volume rate flowing out of the hoist unit is increased by expanding the cross section in the hydraulic path from the hoist unit to the reservoir.

According to one particularly preferred embodiment of the invention, the cross section expansion device is a bypass line that leads from the consumer line to the reservoir.

To enable the bypass line, an electrically actuated hydraulic bypass valve linked with the actuator element is advantageously located in the bypass line.

According to one advantageous variant of the invention, the cross section expansion device is an additional valve in the control valve device.

In an additional potential configuration the cross section expansion device comprises a lowering proportional throttle valve that can optionally carry a full flow or a partial flow.

A control device, preferably an electronic control device, is provided to control the cross section expansion device, which control device is linked with the hoist unit control element and with the authorization actuation element as well as with the cross section expansion device.

According to one preferred development of the teaching of the invention, safety devices are provided to assist the operator to prevent an actuation of the high-speed lowering when a load is present on the load handling means.

For this purpose a load pressure sensor is provided for the determination of the load pressure on the hoist unit, which is linked with the control device so that the load pressure values measured can be transmitted to the control device. The control device is designed to block the triggering of the high-speed lowering operation when a load pressure that exceeds a specified limit value is transmitted.

Additionally or alternatively, a temperature sensor as a safety device for the determination of the temperature of the hydraulic medium is provided which is linked with the control device so that the temperature values measured can be transmitted to the control device. In this case, the control device is designed to block the initiation of the high-speed lowering operation when a temperature that that exceeds a specified limit value is transmitted.

The invention offers a whole series of advantages.

The invention achieves more rapid storage and retrieval operations by a 50% performance increase in all lowering processes.

The pick rate during logistics processes is increased. An additional result is increased vehicle availability.

The industrial truck can also travel more quickly to the next work site, because it may never travel with the load handling means raised.

Finally, an improved user experience for the operator is also expected, because the invention gives the operator more autonomy and decision-making opportunities. The operator is more effectively integrated into the process and the operation of the industrial truck.

### BRIEF DESCRIPTION OF THE DRAWINGS

The terms Fig., Figs., Figure, and Figures are used interchangeably in the specification to refer to the corresponding figures in the drawings.

Additional advantages and details of the invention are described in greater detail below with reference to the exemplary embodiments illustrated in the accompanying schematic figures, in which

FIG. 1 is a schematic diagram of a hoist unit according to the invention, and

FIG. 2 shows the hoist unit control element with the authorization actuation element.

### DESCRIPTION OF THE INVENTION

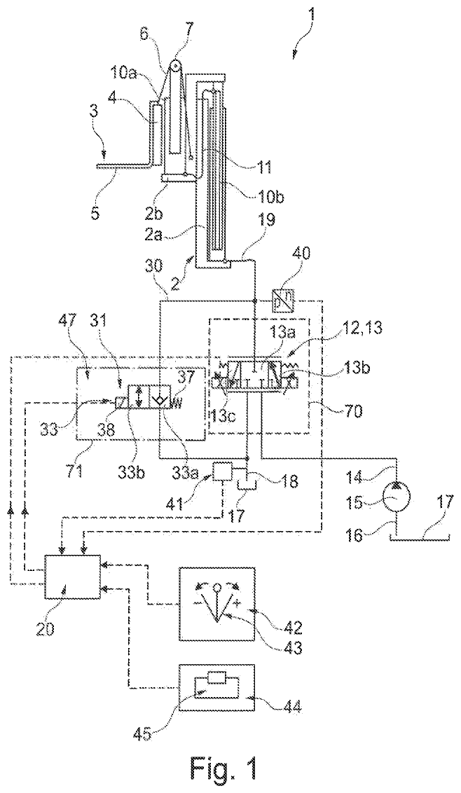

FIG. 1 is a schematic illustration of a hydraulic hoist drive 1 according to the invention of a mobile machine such as an industrial truck, for example, which is not illustrated in any further detail.

The hoist unit 1 has a lift frame 2, on which are located load handling means that can be raised and lowered. In the illustrated exemplary embodiment, the load handling means or device 3 consist in particular of a lift carriage 4 that can move vertically on a lift frame 2, to which is fastened, for example, a load fork 5 formed by fork tips as an accessory device.

In the illustrated exemplary embodiment, the lift frame 2 consists of a stationary mast 2a and a telescoping mast 2b that can be raised and lowered on the stationary mast 2a, with load handling means or device 3 that can be raised and lowered located on the telescoping mast 2b.

The lift frame 2 in FIG. 1 has two lifting stages, for example. A hydraulic lift cylinder device 10a is provided to raise and lower the load handling means 3 relative to the telescoping mast 2b. The lift cylinder device 10 forms a first lifting stage (free lift). To raise and lower the load handling means 3, flexible traction means or device 6 such as a hoist chain, for example, are provided, which in FIG. 1 is fastened by a first end to the load carriage 4, guided by means of a deflector roller 7 on the telescoping piston rod of the lift cylinder device 10a, and is fastened by a second end to the telescoping mast 2b. A hydraulic lift cylinder device 10b raises and lowers the telescoping mast 2b relative to the stationary mast 2a. The lift cylinder device 10b forms a second lifting stage (mast lift). The lift cylinder device 10a is connected with the lift cylinder device 10b by means of a hydraulic line 11.

The lift cylinder device 10a, 10b can be actuated by means of a control valve device 12 with which the raising and lowering of the load handling means 3 can be controlled.

The control valve device 12 in the illustrated exemplary embodiment is in the form of a proportional valve that throttles in intermediate positions, with a closed position 13a in the form of a neutral position, a lifting position 13b and a lowering position 13b. For this purpose, the control valve device 12 is connected to a delivery line 14 of a pump 15, which by means of a suction line 16 sucks hydraulic fluid out of a reservoir 17, to a reservoir line 18 that leads to the reservoir 17, and to a hydraulic line 19 that leads to the lift cylinder device 10a, 10b. In the closed position 13a of the control valve device 12, the connection of the consumer line 19 with the delivery line 14 and the reservoir line 18 is shut off. In the lifting position 13b of the control valve device, the delivery line 14 is in communication with the consumer line 19. In the lowering position 13b of the control valve device 12, the consumer line 19 is in communication with the reservoir line 18. The lowering position 13b of the control valve device 12 therefore forms a lowering proportional throttle valve.

Alternatively, the control valve device 12 can have a separate lifting valve (lifting proportional throttle valve) for controlling the lifting operation of the load handling means 3 and a separate lowering valve (lowering proportional throttle valve) to control the lowering operation of the load handling means 3.

The control valve device 12 can be actuated electrically, for example, by means of an electronic control device 20.

In the reservoir line 18 leading from the control valve device 12 to the reservoir 17, there can be a discharge pressure balance that is not shown in any further detail. The discharge pressure balance is preferably in the form of a proportional valve that throttles in intermediate positions, with a flowthrough position and a closed position, and is actuated toward the flowthrough position by a spring device and the pressure present in the reservoir line 18 between the control valve device 12 and the discharge pressure balance and thus downstream of the control valve device 12, and toward the closed position by the load pressure of the hoist unit 1 present in the consumer line 19, and thus the pressure present in the consumer line 19 upstream of the control valve device 12.

To achieve an increased lowering speed during lowering of the hoist unit 1 without a load, according to the invention a cross section expansion device 47 is provided with which the lowering flow volume can be increased to increase the lowering speed. For this purpose, in the illustrated exemplary embodiment a bypass line 30 in which a bypass valve 31 is located and that leads to the reservoir 17 is in communication with the consumer line 19.

In the illustrated exemplary embodiment, the bypass valve 31 is in the form of a switch valve 33 which has a closed position 33a and a flowthrough position 33b. In the illustrated exemplary embodiment, the closed position 33a is leak tight and has a check valve that closes toward the reservoir 17.

The switch valve 33 is electrically actuated and is linked to the electronic control device 20 for its actuation.

In the illustrated exemplary embodiments, the switch valve 33 is actuated toward the closed position 33a by a spring device 37 and toward the lowering position 33b by means of an electrical actuator device 38 such as an actuating magnet, for example.

The bypass valve 31 is designed so that during the lowering of the hoist unit 1 without a load on the load handling means 3, a lowering flow volume out of the hoist unit 1 flows via the control valve device 12 and the bypass valve 31 into the reservoir 17, and during the lowering of the hoist unit 1 with a load on the load handling means 3, a lowering flow volume out of the hoist unit 1 is discharged exclusively via the control valve device 12 into the reservoir 17.

For this purpose, as illustrated in FIG. 1, the electronic control device 20 is linked with a hoist unit control element 42, which in the present exemplary embodiment comprises a deflectable lever 32 such as a joystick, for example, and with an authorization actuation element 44, which in the present exemplary embodiment comprises a depressible button 45 on the lever 43.

If the operator (not shown in FIG. 1) detects that there is no load on the load handling means 3, the operator can authorize a high-speed lowering of the load handling means 3, in which the lowering flow volume discharged from the hoist unit 1 flows into the reservoir 17 via the control valve device 12 and the bypass valve 31. A two-factor authorization is provided for this purpose.

Two-factor authorization means that simultaneously with the operation of the hoist unit control element 42, i.e. simultaneously with the deflection of the lever 43 in the lowering direction, the operator continuously actuates the authorization actuation element 44, i.e. presses the button 45 and keeps it depressed during the lowering of the load handling means 3. The control commands initiated from the hoist unit control element 42 and the authorization actuation element 44 are transmitted to the control device 20.

The electronic control device 20 is designed so that when the hoist unit control element 42 and the authorization actuation element 44 are actuated simultaneously during a lowering operation without a load, the control valve device 12 is actuated into the lowering position 13b and the switch valve 33 into the flowthrough position 33b for high-speed lowering. On the other hand, during lowering with a load, only the control valve device 12 is actuated into the lowering position 13b, although the switch valve 33 is not driven and is actuated into the closed position 33a.

The control device 20 is also linked with a load pressure sensor 40 that measures the load pressure present in the consumer line 19 of the hoist unit 1, and/or a temperature sensor 41 that measures the temperature of the hydraulic medium. For this purpose, the control device 20 is designed to block the initiation of the high-speed lowering operation when a load pressure that exceeds a specified limit value and/or a temperature that exceeds a specified limit is transmitted. This represents an additional safety measure.

In FIG. 1, the control valve device 12 is located in a multi-way valve block 70. Additional control valves (not shown) of a hydraulic system of the mobile machine can be located in the multi-way valve block 70, for example a control valve for tilting the lifting frame 2 and a control valve for the control of an additional consumer, for example a side shifting device of the load handling means 3.

The bypass valve 31, which in FIG. 1 comprises the switch valve 33, is located in a separate valve housing 71. This makes it possible in a simple manner to retrofit the bypass valve 31 and the bypass line 30 on existing hoist units 1. The flow volume in the bypass line 30 during high-speed lowering therefore bypasses the multi-way valve block 70, as a result of which its flow losses are eliminated.

The hoist unit in FIG. 1 works as follows:

If the hoist unit 1 is lowered with a load, in which case the hoist unit control element 42 is actuated into the lowering position without the additional actuation of the authorization actuation element 44, the bypass valve 31 is not active. The switch valve 33 is not triggered by the control device 20 and is in the closed position 33a, so that the lowering of the hoist unit 1 takes place exclusively by means of the control valve device 12 actuated into the lowering position 13b. Therefore no lowering flow volume flows out via the bypass valve 31 from the lift cylinder device 10a, 10b to the reservoir 17.

If the hoist unit 1 is lowered without a load, in which case the hoist unit control element 42 is actuated into the lowering position and the authorization actuation element 44 is actuated simultaneously, the bypass valve 31 is active for the high-speed lowering. The switch valve 33 is triggered into the flowthrough position 33 by the control device 20b. The hoist unit 1 is therefore lowered by means of the control valve device 12 actuated into the lowering position 13b and additionally via the opened bypass valve 31. An additional lowering flow volume is therefore achieved by means of the switch valve 33 actuated into the flowthrough position 33b, which flows out of the lift cylinder device 10a, 10b to the reservoir 17. This additional lowering flow volume via the bypass valve 30 makes possible a higher lowering speed without a load.

If, during an actuation of the hoist unit control element 42 into the lowering position with the simultaneous actuation of the authorization actuation element 44, the load pressure sensor 40 measures a load pressure above the limit value and/or the temperature sensor 41 measures a temperature of the hydraulic medium above the limit value, the control device 20 blocks the triggering of high-speed lowering and the switch valve 33 is not triggered into the flowthrough position 33b, so that the lowering takes place exclusively via the control valve device 12 actuated into the lowering position 13c.

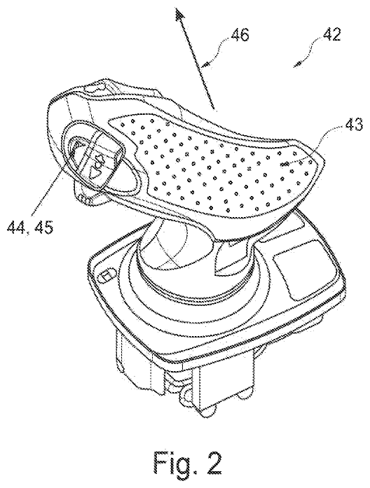

FIG. 2 shows a detail of the hoist unit control element 42 with the authorization actuation element 44 from FIG. 1. In the present case, the hoist unit control element 42 is in the form of a deflectable lever 43 such as a joystick, for example, while the authorization actuation element 44 is in the form of a button 45 which is located on the side of the lever 43.

The operator controls the lowering process by manually deflecting the lever 43 in the direction 5 indicated by the arrow 46. If the operator detects that there is no load on the load handling means 3, the high-speed lowering operation can be initiated by two-factor authorization. For that purpose, the operator simultaneously deflects the lever 43 in the direction indicated by the arrow 46 and, with his or her thumb presses the button 45 and keeps it depressed continuously during the lowering process.

1. A method for controlling a hydraulic hoist unit of a mobile machine to raise and lower a load handling, wherein the hoist unit comprises a lift cylinder device and a control valve device which is in communication with a consumer line that leads to the lift cylinder device, to a reservoir line that leads to a reservoir, and to a delivery line that is connected with a pump, the method comprising an operator controlling the raising and lowering the hoist unit by manually operating a hoist unit control element that is linked to the control valve device, and, when there is no load on the load handling device during lowering of the hoist unit, the operator, by actuating an authorization actuation element while simultaneously operating the hoist unit control element, authorizes a high-speed lowering, during which a lowering flow volume discharged from the hoist unit is increased by a cross section expansion by a cross section expansion device in a hydraulic flow path from the hoist unit to the reservoir.

2. The method according to claim 1, wherein the cross section expansion is achieved by opening a bypass line leading from the consumer line to the reservoir.

3. The method according to claim 2, wherein an electrically actuated hydraulic bypass valve is opened to open the bypass line.

4. The method according to claim 1, wherein the cross section expansion is achieved by opening an additional valve in the control valve device.

5. The method according to claim 1, wherein the cross section expansion is achieved by routing a full flow through a lowering proportional throttle valve that carries a partial flow during the lowering of the hoist unit.

6. The method according to 1, wherein load pressure of the hoist unit is measured by a load pressure sensor, and the cross section expansion is prevented if the load pressure exceeds a specified value.

7. The method according to claim 1, wherein temperature of the hydraulic medium is measured by a temperature sensor, and the cross section expansion is prevented if the temperature exceeds a specified value.

8. A device for controlling a hydraulic hoist unit of a mobile machine for raising and lowering a load handling wherein the hoist unit comprises a lifting cylinder device and a control valve device, which is in communication with a consumer line that leads to the lift cylinder device, to a reservoir line that leads to a reservoir, and to a delivery line that is connected to a pump, wherein a manually operable hoist unit control element for the control of the lifting and lowering of the hoist unit is provided and which is linked with the control valve device, and wherein a manually actuatable authorization actuation element that can be actuated simultaneously with the hoist unit control element is provided, which is linked to a cross section expansion device to increase the flow volume in a hydraulic flow path the hoist unit to the reservoir.

9. The device according to claim 8, wherein the cross section expansion device comprises a bypass line that leads from the consumer line to the reservoir.

10. The device according to claim 9, wherein the bypass line, there is an electrically actuated, hydraulic bypass valve that is linked to the authorization actuation element.

11. The device according to claim 8, wherein the cross section expansion device comprises an additional valve in the control valve device.

12. The device according to claim 8, wherein the cross section expansion device comprises a lowering proportional throttle valve in the control valve device that can carry a full flow or a partial flow.

13. The device according to claim 8, wherein, for the control of the cross section expansion device, an electronic control device is provided which is linked with the hoist unit control element and the authorization actuation element as well as with the cross section expansion device.

14. The device according to claim 13, wherein a load pressure sensor is provided for the determination of load pressure of the hoist unit and is linked with the control device.

15. The device according to claim 13, wherein a temperature sensor is provided for the determination of temperature of the hydraulic medium and is linked with the control device.
